(19) United States
(12) Patent Application Publication
(10) Pub. No.: US 2017/0147038 A1
(43) Pub. Date: May 25, 2017

(54) CONVERTIBLE DUAL SCREEN LAPTOP

(71) Applicant: Elizabeth Cody, Peculiar, MO (US)

(72) Inventor: Elizabeth Cody, Peculiar, MO (US)

(21) Appl. No.: 14/952,077

(22) Filed: Nov. 25, 2015

(51) Int. Cl. G06F 1/16

(52) U.S. Cl. CPC G06F 1/1649; G06F 1/1662; G06F 1/1681

(57) ABSTRACT

A dual screen laptop assembly that includes: a laptop computer, where the laptop computer includes a primary screen and keyboard, where the primary screen is hinged one side of a base and lifts to an upright position during use thereof; a second screen, wherein the second screen attaches to the primary screen; a first set of vertical tracking on a rear surface of the primary screen; a second set of vertical tracking on a rear surface of the secondary screen, where the first set of vertical tracking and second set of vertical tracking enable positioning of the second screen on a first side or a second side of the primary screen; and a set of horizontal tracking on the rear surface of the primary screen, where the set of horizontal tracking enables placement of the second screen above the primary screen. The first side may be a left side of the primary screen and the second side may be a right side of the primary screen.

### BACKGROUND OF THE INVENTION

Field of Invention

The field of invention relates to a convertible dual screen laptop that includes a primary screen and a secondary screen.

Description of Related Art

Personal computers are a very common electronic advice, which has inundated modern society. Many people not only have laptop computer but also tablets and smart phones, which provide further computing capabilities. However the most common and powerful portable electronic device still remains the laptop due to the storage capacity and multiple functional abilities available on the laptop. One drawback to the laptop is the single screen that is available for the user. Many users of desktops may use dual screens based upon their particular profession. The dual screens enable the user to have multiple softwares and applications on multiple displays. This dual screen capability is clearly capable with the typical desktop computer however there appears to be limited opportunities for such laptop applications. As a result, it would be advantageous to have an extra screen or a dual screen capability that is flexibly used by a laptop user.

### SUMMARY OF THE INVENTION

The present invention relates to a dual screen laptop assembly that includes: a laptop computer, where the laptop computer includes a primary screen and keyboard, where the primary screen is hinged one side of a base and lifts to an upright position during use thereof; a second screen, wherein the second screen attaches to the primary screen; a first set of vertical tracking on a rear surface of the primary screen; a second set of vertical tracking on a rear surface of the secondary screen, where the first set of vertical tracking and second set of vertical tracking enable positioning of the second screen on a first side or a second side of the primary screen; and a set of horizontal tracking on the rear surface of the primary screen, where the set of horizontal tracking enables placement of the second screen above the primary screen. The first side may be a left side of the primary screen and the second side may be a right side of the primary screen.

### BRIEF DESCRIPTION OF DRAWINGS

FIG. 1 depicts a first embodiment of a dual screen laptop in accordance with the present invention.

FIG. 2 depicts a second embodiment of the dual screen laptop in accordance with the present invention.

FIG. 3 depicts a third embodiment of the dual screen laptop in accordance with the present invention.

FIG. 4 depicts a side view and back view of the dual screen laptop in accordance with the present invention.

### DETAILED DESCRIPTION

The present invention relates to a convertible dual screen laptop that provides a secondary screen for a conventional laptop computer. The secondary screen according to the present invention may be positioned above the primary screen in one particular embodiment by using horizontal tracking on the rear of the primary screen and adjoining tracking on the secondary screen. As an alternative the screen may also be attached to either side of the primary laptop screen either on the left or right side of the primary screen. This attachment and conversion is available and due to tracking available on the rear or backside of the primary screen and adjoining to the secondary screen. Horizontal tracks on the primary screen and secondary screen enable the secondary screen to be positioned vertically above the primary screen. Vertical tracks on the primary screen and the secondary screen enable the secondary screen to be placed on either side of the primary screen.

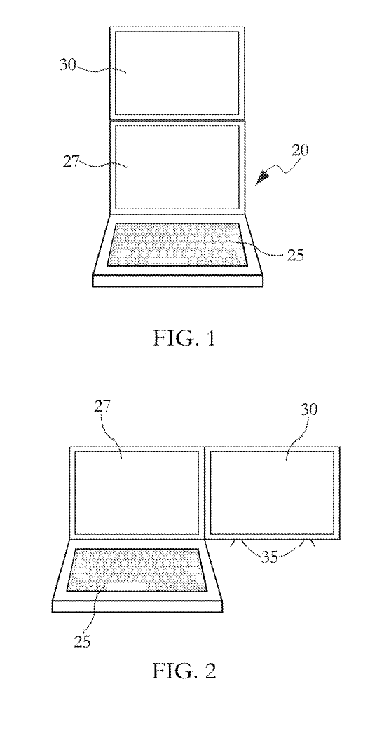

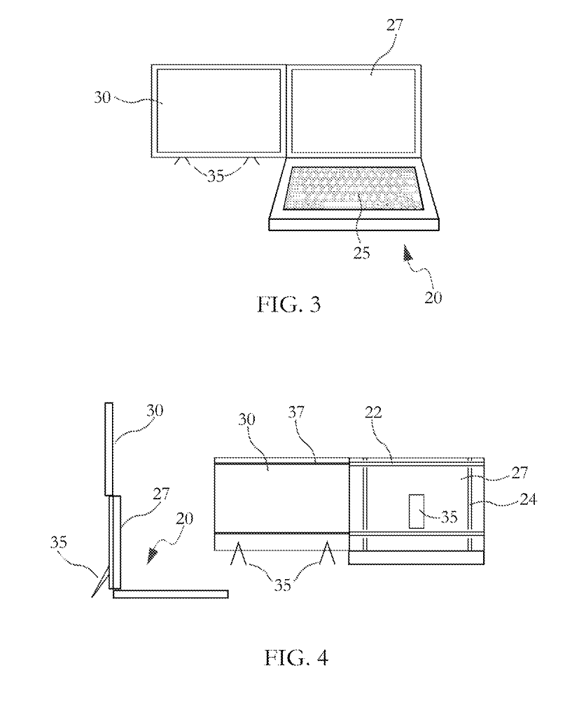

In reference to FIG. 1, a first configuration of the present invention is depicted. A laptop 20 is shown with a primary screen 27 and a keyboard 25 configured as a traditional laptop. Screen 27 flips upward to expose the keyboard 25, which is readily available by the user. Above the primary screen 27 is a secondary screen 30 attached above the primary screen 27 using horizontal tracking on the back of the primary screen 27. This configuration provides a vertical positioning of the screens so the user has the secondary screen 30 above the primary screen 27. This secondary screen 30 may be moved from the position shown in FIG. 1 to the position shown in FIG. 2, where the secondary screen 30 is secured to vertical tracking on the back of the primary screen 27 and positioned on the right side thereof. When placed in this side position a set of support brackets 35 are provided to support the secondary screen 30 in a stationary position. Alternatively the secondary screen 30 may be placed on the left side as shown in FIG. 3 again with leg supports 35. These horizontal or vertical options are provided through the use of tracking on the secondary screen 30 and on the back of the primary screen 27.

In FIG. 4, tracking 37 is depicted along the surface of the secondary screen 30. This tracking 37 engages horizontal tracking 22 provided on the primary screen 27. The horizontal tracking 22 is shown on the backside of the primary screen 27. Vertical tracking 24 is also shown on the primary screen 27 that enables the side placement of the secondary screen 30. Also shown in FIG. 4 is a side view showing the vertical placement of secondary screen 30 above the primary screen 27. An additional support bracket 35 is provided on the primary screen 27 and used when the secondary screen 30 is placed above the primary screen 27. As configured, this present invention enables easy attachment and movement of a secondary screen in conjunction and onto a primary screen of a laptop computer. As a further feature of the present invention, the tracking system may be installed onto an existing laptop computer, therefore enabling the addition of a secondary screen. The secondary screen may also be stored directly behind the primary screen for storage purposes. The instant invention has been shown and described in what it considers to be the most practical and preferred embodiments. It is recognized, however, that departures may be made there from within the scope of the invention and that obvious modifications will occur to a person skilled in the art.

1. (canceled)

2. (canceled)

3. (canceled)

4. A dual screen laptop assembly comprising:
a. a laptop computer, where the laptop computer includes a primary screen and keyboard, where the primary screen is hinged one side of a base and lifts to an upright position during use thereof;
b. a second screen, wherein the second screen attaches to the primary screen;
c. a first set of vertical tracking on a rear surface of the primary screen;
d. a second set of vertical tracking on a rear surface of the secondary screen, where the first set of vertical tracking and second set of vertical tracking enable positioning of the second screen on a first side or a second side of the primary screen; and
e. a set of horizontal tracking on the rear surface of the primary screen, where the set of horizontal tracking enables placement of the second screen above the primary screen.

5. The dual screen laptop assembly according to claim 1, where the first side is a left side of the primary screen.

6. The dual screen laptop assembly according to claim 1, where the second side is a right side of the primary screen.

7. The dual screen laptop assembly according to claim 1, where the secondary screen includes support brackets, where support brackets are used when the secondary screen is on either the first side or second side.

8. The dual screen laptop assembly according to claim 1, where the primary screen includes a support bracket, where the support bracket is used when the secondary screen is on above the primary screen.
